(19) United States
(12) Patent Application Publication
(10) Pub. No.: US 2013/0089344 A1
(43) Pub. Date: Apr. 11, 2013

(54) FUSING DEVICE OF IMAGE FORMING APPARATUS AND METHOD OF DETECTING LEAKAGE CURRENT THEREOF

(71) Applicants: Chang-seok CHOI, Suwon-si (KR); Han-sang Oh, Seoul (KR)

(72) Inventors: Chang-seok CHOI, Suwon-si (KR); Han-sang Oh, Seoul (KR)

(73) Assignee: Samsung Electronics Co., Ltd, Suwon-si (KR)

(21) Appl. No.: 13/549,675

(22) Filed: Jul. 16, 2012

(30) Foreign Application Priority Data
Oct. 7, 2011 (KR) 10-2011-0102651

(51) Int. Cl. G03G 15/20; H02H 3/16

(52) U.S. Cl. 399/33; 361/45

(57) ABSTRACT

A fusing device of an image forming apparatus including a fusing element in which a heat generation layer is formed and a pressurization element that forms a fusing nip by pressurizing and contacting the fusing element, the fusing device including: a power supplier for supplying a power supply voltage to the heat generation layer to heat the heat generation layer; a current signal detector for detecting a current signal corresponding to a difference between an input current of the heat generation layer and an output current of the heat generation layer; a determination unit for determining whether current leaks out of the heat generation layer by analyzing the current signal detected by the current signal detector; and a power breaker for preventing the power supply voltage, supplied from the power supplier, from being supplied to the heat generation unit, if the determination unit determines that current leaks out of the heat generation layer.

### CROSS-REFERENCE TO RELATED APPLICATIONS

This application claims the benefit of Korean Patent Applications No. 10-2011-0102651, filed on Oct. 7, 2011, in the Korean Intellectual Property Office, the disclosure of which is incorporated herein in its entirety by reference.

### BACKGROUND OF THE INVENTION

1. Field of the Invention

The present invention relates to a fusing device including a fusing element in which a heat generation layer is formed, and more particularly, to a method and apparatus of sensing leakage current that leaks out of the heat generation layer.

2. Description of the Related Art

In image forming apparatuses, a process of forming an image on a print medium is performed as follows. First, a photosensitive medium is exposed to light, thereby forming an electrostatic latent image thereon, and then a developing agent is provided to the electrostatic latent image to develop the image. In other words, charged particles of the developing agent are distributed on a surface of the photosensitive medium according to the electrostatic latent image. Then, the image formed on the photosensitive medium is transferred onto a print medium. That is, the particles of the developing agent on the surface of the photosensitive medium are transferred onto the print medium. Lastly, the developing agent transferred onto the print medium is heated and pressurized to be fused thereon, thereby completing formation of the image.

The process of fusing the developing agent transferred onto the print medium may be performed using a fusing device included in the image forming apparatus. In detail, the print medium onto which the developing agent is transferred is passed through a fusing nip formed by pressurization contact between a fusing belt and a pressurization roller of the fusing device, thereby applying pressure to the print medium, and, at this time, the fusing belt applies heat to the print medium passing through the fusing nip.

Heat necessary for fusing is supplied to the print medium by heating the fusing belt of the fusing device. In order to heat the fusing belt, a heater such as a halogen lamp may be included inside a heating roller contacting the fusing belt, or a surface heating element may be disposed on the surface of the fusing belt.

In a basic structure of the fusing belt including the surface heating element, a surface heating element layer is formed on a support layer that is a base, and an insulation layer is formed on the surface heating element layer. In this structure, current flows through the surface heating element layer by directly supplying a power supply voltage to the surface heating element layer to heat it. Thus, the insulation layer is formed on the surface heating element layer to prevent a mechanical problem and an electric shock of a user.

Unlike a structure in which heat is received from a heat generating element prepared in a fusing roller or a fusing belt, the structure in which the fusing belt includes the surface heating element has a high thermal efficiency since the surface of the fusing belt is directly heated. On the contrary, in the structure in which the fusing belt includes the surface heating element, if the insulation layer covering the surface heating element is damaged or the fusing belt is broken, a mechanical problem or an electric shock of a user may occur due to a current flowing through the surface heating element.

### SUMMARY OF THE INVENTION

The present inventive concept provides a method of sensing current that leaks out of a surface heating element of a fusing belt.

The present inventive concept also provides an apparatus to sense leakage current that leaks out of a surface heating element of a fusing belt.

Additional features and utilities of the present general inventive concept will be set forth in part in the description which follows and, in part, will be obvious from the description, or may be learned by practice of the general inventive concept.

In exemplary embodiments of the present inventive concept, there is provided a fusing device of an image forming apparatus including a fusing element in which a heat generation layer is formed and a pressurization element that forms a fusing nip by pressurizing and contacting the fusing element, the fusing device including: a power supplier to supply a power supply voltage to the heat generation layer to heat the heat generation layer; a current signal detector to detect a current signal corresponding to a difference between an input current of the heat generation layer and an output current of the heat generation layer; a determination unit to determine whether current leaks out of the heat generation layer by analyzing the current signal detected by the current signal detector; and a power breaker to prevent the power supply voltage, supplied from the power supplier, from being supplied to the heat generation layer if the determination unit determines that current leaks out of the heat generation layer.

The determination unit may determine that current leaks out of the heat generation layer if a frequency of the current signal detected in the current signal detector coincides with a frequency of the power supply voltage supplied to the heat generation layer.

The determination unit may determine that current leaks out of the heat generation layer if the number of pulses of the current signal detected in the current signal detector is equal to or more than a predetermined value.

The fusing element may include a roller or belt that rotates at a predetermined period, and the determination unit may determine that current leaks out of the heat generation layer if a period in which a pulse group comprising a plurality of pulses of the current signal is generated coincides with the rotation period of the fusing element.

The pressurization element may include a conductive material and may allow leakage current, which leaks out of the heat generation layer of the fusing element, to flow to the ground.

Only if the print medium is not input to the fusing nip, the determination unit may determine whether current leaks out of the heat generation layer.

The pressurization element may be connected to an input-output power supply line of the heat generation layer in a Y-connection form.

The fusing device may further include a conductive element allowing current leaked out of the fusing element to flow to the ground by contacting the fusing element at one or more points of the fusing element.

The conductive element may include a roller form that contacts the fusing element and rotates as the fusing element rotates, or a brush form that contacts the fusing element at a fixed position.

The conductive element may be connected to an input-output power supply line of the heat generation layer in a Y-connection form.

In exemplary embodiments of the present inventive concept, there is also provided a method of sensing leakage current of a fusing device of an image forming apparatus comprising a fusing element in which a heat generation layer is formed and a pressurization element that forms a fusing nip by pressurizing and contacting the fusing element, the method including: supplying a power supply voltage to the heat generation layer to heat the heat generation layer; detecting a current signal corresponding to a difference between an input current of the heat generation layer and an output current of the heat generation layer; determining whether current leaks out of the heat generation layer by analyzing the detected current signal; and preventing the power supply voltage from being supplied to the heat generation layer if it is determined that current leaks out of the heat generation layer.

The determining may include determining that current leaks out of the heat generation layer if a frequency of the detected current signal coincides with a frequency of the power supply voltage supplied to the heat generation layer.

The determining may include determining that current leaks out of the heat generation layer if the number of pulses of the detected current signal is equal to or more than a predetermined value.

The fusing element may include a roller or belt that rotates at a predetermined period, and the determining may include determining that current leaks out of the heat generation layer if a period, in which a pulse group comprising a plurality of pulses of the detected current signal is generated, coincides with the rotation period of the fusing element.

The pressurization element may include a conductive material and may allow leakage current, which leaks out of the heat generation layer of the fusing element, to flow to the ground, and, in this case, the determining may be performed only if the print medium is not input to the fusing nip.

In the methods and devices according to the present inventive concept, if current leaks out of a heat generation layer, it is possible to prevent a mechanical problem or an electric shock of a user by sensing the leakage current and breaking a power supply voltage that is supplied to the heat generation layer. In addition, it is possible to effectively distinguish noise such as static electricity from leakage current by analyzing a current signal detected in the heat generation layer and thereby determining whether current leaks out of the heat generation layer. In addition, by forming a pressurization element, which forms a fusing nip by contacting a fusing element, with a conductive material to make a path through which leakage current flows to the ground, it is possible to configure the fusing device without adding any additional elements.

Exemplary embodiments of the present general inventive concept also provides a fusing device of an image forming apparatus including a fusing belt having a heat generation layer configured to receive a power supply voltage in order to heat the generation layer, a pressurization element which forms a fusing nip by pressurization contact between the fusing belt and the pressurization element, a current signal detector to detect a change in a current signal of current that flows into the heat generation layer and current that flows out of the heat generation layer, and a determination unit to determine whether a current leaks out of the heat generation layer by analyzing the current signal.

The current signal detector may have an amplifier, and the current signal detector amplifies the detected current signal via the amplifier and transmits the amplified current signal to the determination unit.

The current signal detector may have a zero current transformer for detecting a current signal corresponding to a difference between a first current, which flows through an input power supply line into the heat generation layer, and a second current which flows through an output power supply line from the heat generation layer.

The fusing device may have a power breaker to prevent the heat generation layer from receiving the power supply voltage when the determination unit determines that there is a current leakage.

### BRIEF DESCRIPTION OF THE DRAWINGS

The above and/or other features and utilities of the present general inventive concept will become more apparent by describing in detail exemplary embodiments thereof with reference to the attached drawings in which:

FIG. 1 is a diagram illustrating a fusing device of an image forming apparatus according to an embodiment of the present general inventive concept;

FIGS. 2A and 2B are diagrams illustrating detailed configurations of fusing devices according to other embodiments of the present general inventive concept;

FIGS. 3A and 3B are diagrams illustrating configurations of fusing devices according to other embodiments of the present general inventive concept;

FIG. 4 is a diagram illustrating a waveform of a current signal detected in the current signal detector of FIG. 1; and

FIGS. 5 through 9 are flowcharts explaining a method of sensing leakage current of a fusing device of an image forming apparatus, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 1 is a diagram illustrating a fusing device of an image forming apparatus according to an embodiment of the present inventive concept. Referring to FIG. 1, the fusing device may include a fusing belt 110, a pressurization roller 120, a current signal detector 130, a determination unit 140, a power breaker 150, and a power supplier 160.

The fusing belt 110 may include a heat generation layer for generating heat. In FIG. 1, a heat generation layer 114 is formed on a support layer 116 and then an insulation layer 112 is formed on the heat generation layer 114. The support layer 116 maintains a form of the fusing belt 110, and supports the heat generation layer 114 and the insulation layer 112 formed on the fusing belt 110.

A polyimide film having a high heat-resisting property may be used as a material constituting the support layer 116. However, the present inventive concept is not limited thereto, and the support layer 116 may be thinly formed to allow a relatively fast rise in temperature.

The heat generation layer 114 receives a current and directly generates heat. An alternating current (AC) directly flows through the heat generation layer 114, and the heat generation layer 114 is blocked from the outside by the insulation layer 112 formed thereon. In this manner, this structure in which heat is directly generated near a surface of the fusing belt 110 by disposing the heat generation layer 114 under the surface of the fusing belt 110 is referred to as a surface heating element belt. Since the surface heating element belt directly generates heat near the surface thereof, a rise in temperature is relatively fast and thermal efficiency is relatively high, compared to a fusing belt having a structure in which heat is received from an internal coil or a halogen heater and then indirectly transmitted. On the contrary, in the fusing belt 110 of the surface heating element belt type, since an alternating current (AC) directly flows through the heat generation layer 114, the insulation layer 112 formed on the heat generation layer 114 may be damaged or the fusing belt 110 may be broken, thereby exposing the heat generating layer 114 to the outside. In this case, there exists a danger of an electric shock of a user and a danger of fire. Thus, when current leaks out of the heat generation layer 114, it is necessary to quickly and accurately sense the leakage current and cut a supply of power.

A driving roller 117 contacts a portion of an inner surface of the fusing belt 110, and thus the fusing belt 110 rotates as the driving roller 117 rotates. Then, a nip element 118 contacts another portion of the inner surface of the fusing belt 110, and thus a fusing nip 122 may be formed by pressurization contact between the fusing belt 110 and a pressurization roller 120. A print medium onto which a developing agent is transferred is passed through the fusing nip 122, thereby applying pressure to the print medium and also applying heat from the fusing belt 110 to the print medium, and thus the developing agent is fused on the print medium.

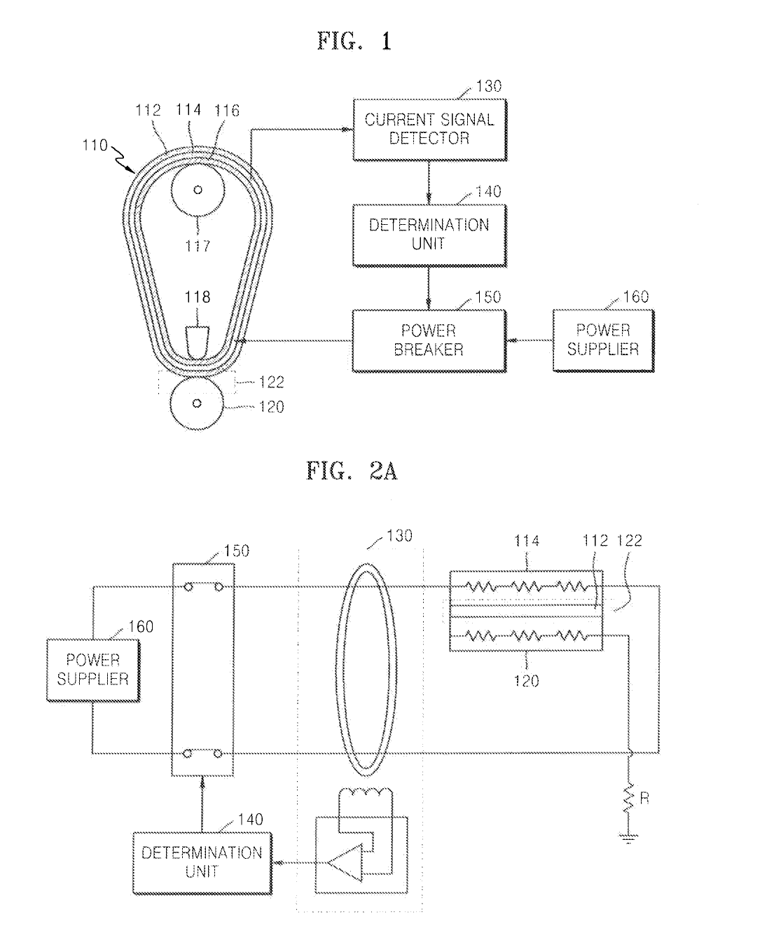

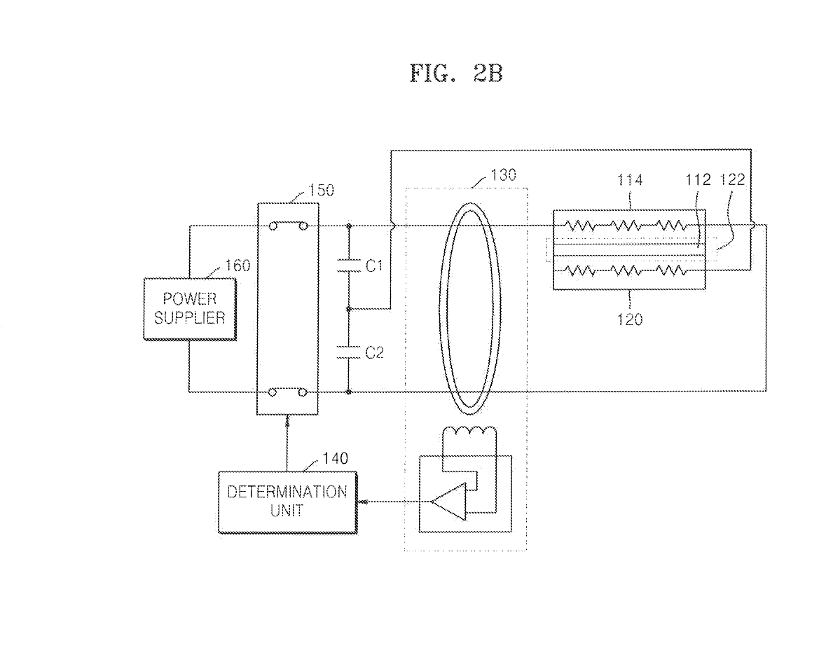

The pressurization roller 120 is formed of a conductive material and is connected to the ground, and thus it is possible to allow leakage current to flow from the pressurization roller 120 to the ground when leakage current leaks out of the heat generation layer 114. For example, if part of the insulation layer 112 is damaged, the pressurization roller 120 contacts the heat generation layer 114 of the fusing belt 110 at the fusing nip 122, and thus an alternating current (AC) flowing through the heat generation layer 114 flows to the ground through the pressurization roller 120 formed of a conductive material. In other words, if the heat generation layer 114 is exposed to the outside due to damage of the insulation layer 112, leakage current may be generated. The pressurization roller 120 may be connected to a frame ground or connected to an input-output power supply line of the heat generation layer 114, in a Y-connection form, through a resistor or a capacitor, to allow leakage current to flow from the pressurization roller 120 to the ground. A detailed explanation of this will be described with reference to FIGS. 2A and 2B below.

The current signal detector 130 detects a current signal corresponding to a difference between an input current, that is input to the heat generation layer 114, and an output current that is output from the heat generation layer 114. When the input current and the output current are equal to each other, the current signal corresponding to the difference is not detected, but when the output current is smaller than the input current, the current signal corresponding to the difference is detected, and it is for this reason that the current signal corresponding to the difference is detected. That is, it may be determined that current leaks out of the heat generation layer 114 if the current signal is detected by the current signal detector 130.

However, it may not be determined for certain that current leaks out of the heat generation layer 114 even if the current signal is detected by the current signal detector 130. This is because the current signal may be detected due to a cause other than a current leakage. For example, since the current signal may be detected due to static electricity and the like, it is necessary to clearly distinguish the current signal detected due to current leakage from other noise. For this, a determination algorithm may be executed in the determination unit 140 included in the fusing device according to the present embodiment. In addition, the current signal detector 130 may be constituted by a zero current transformer (ZCT) configured as illustrated in FIGS. 2A and 2B, but the present invention is not limited thereto.

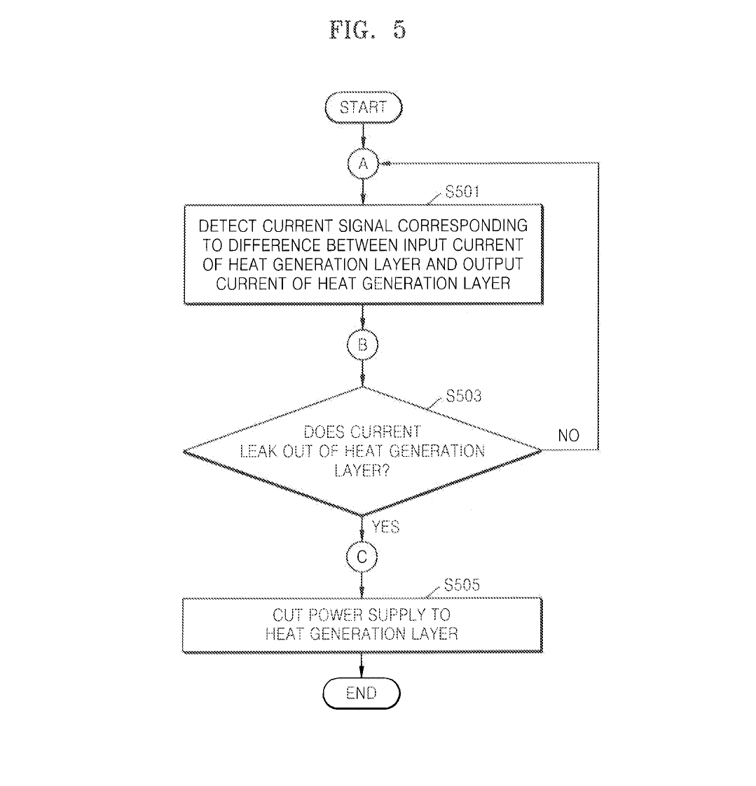

The determination unit 140 may determine whether current leaks out of the heat generation layer 114 by analyzing the current signal detected in the current signal detector 130. A detailed method of determining, in the determination unit 140, whether current leaks out of the heat generation layer 114 by analyzing the current signal will be described with reference to FIG. 4 below. If the determination unit 140 determines that current leaks out of the heat generation layer 114, the power breaker 150 may prevent a power supply voltage, supplied from the power supplier 160, from being supplied to the heat generation layer 114.

The determination unit 140 may determine whether a print medium is input to the fusing nip 122, and may determine whether current leaks out by analyzing the detected current signal only in a case where the print medium is not input to the fusing nip 122. In a state in which the print medium is input to the fusing nip 122, even if the heat generation layer 114 is exposed due to damage of the insulation layer 112 of the fusing belt 110, the exposed heat generation layer 114 does not contact the pressurization roller 120. In this case, since the print medium is between the exposed heat generation layer 114 and the pressurization roller 120, the print medium functions as an insulation layer, and thus current does not leak out. Thus, in a state in which the print medium is input to the fusing nip 122, the determination unit 140 does not determine whether current leaks out since it is difficult to accurately determine whether a current leaks out.

In the present embodiment, it is possible to accurately sense current leakage by detecting a current signal corresponding to a difference between an input current of the heat generation layer 114 and an output current of the heat generation layer 114 and determining whether there is leakage current by analyzing the detected current signal. And then, it is possible to prevent accidents such as an electric shock and a fire by cutting power supply based on the determined result.

FIGS. 2A and 2B are diagrams illustrating detailed configurations of fusing devices according to other embodiments of the present inventive concept. FIG. 2A illustrates a case where a pressurization roller 120 is connected to a frame ground, and FIG. 2B illustrates a case where the pressurization roller 120 is connected to a power supply line in a Y-connection form.

Referring to FIG. 2A, a power supplier 160 may supply a power supply voltage to a heat generation layer 114, and the heat generation layer 114 may generate heat through its resistance by using the received power supply voltage. Since the heat generation layer 114 is in contact with the pressurization roller 120, which is formed of a conductive material, through an insulation layer 112, a current flowing through the heat generation layer 114 flows to the pressurization roller 120, if the insulation layer 112 is damaged, and the current flows to the ground through a resistor R since the pressurization roller 120 is connected to the ground. As illustrated in FIG. 1, the pressurization roller 120 may be connected to a frame ground. If current leaks out of the heat generation layer 114 due to damage of the insulation layer 112, a current difference is generated between an input current of the heat generation layer 114 and an output current of the heat generation layer 114, and a current signal detector 130 detects a current signal corresponding to the current difference.

The current signal detector 130 includes a zero current transformer (ZCT) and thereby may detect a current signal corresponding to a difference between two currents flowing through two power supply lines. In FIG. 2A, since the ZCT of a round shape includes therein a power supply line through which an input current is input to the heat generation layer 114, and a power supply line through which an output current is output from the heat generation layer 114, the current signal detector 130 may detect a current signal corresponding to a difference between the two currents flowing through the two power supply lines. Since a detected current signal may be very small, the current signal detector 130, which includes an amplifier, amplifies the detected current signal and then transmits the amplified current signal to the determination unit 140. The determination unit 140 determines whether current leaks out of the heat generation layer 114 by analyzing the current signal detected by the current signal detector 130, and transmits a determination result to the power breaker 150. A detailed method of determining, in the determination unit 140, whether current leaks out of the heat generation layer 114 by analyzing the current signal will be described with reference to FIG. 4 below. The power breaker 150 may be constituted in a simple switch form as illustrated in FIG. 2A, but may be constituted in various other forms. When the power breaker 150 receives a determination result indicating that current has leaked out from the determination unit 140, the power breaker 150 may prevent the power supply voltage, supplied by the power supplier 160, from being supplied to the heat generation layer 114 by opening a switch.

As illustrated in FIG. 2B, the pressurization roller 120 may be connected to a power supply line in a Y-connection form, instead of being connected to a frame ground, to provide a path for leakage current. Referring to FIG. 2B, the pressurization roller 120 is connected to an input-output power supply line that transmits a power supply voltage to the heat generation layer 114 through two capacitors C1 and C2, in a Y-connection form. Although FIG. 2B illustrates a case where the pressurization roller 120 is connected to an input-output power supply line in a Y-connection form through the capacitors C1 and C2, the pressurization roller 120 may also be connected to the input-output power supply line in a Y-connection form through resistors (not shown) instead of the capacitors C1 and C2.

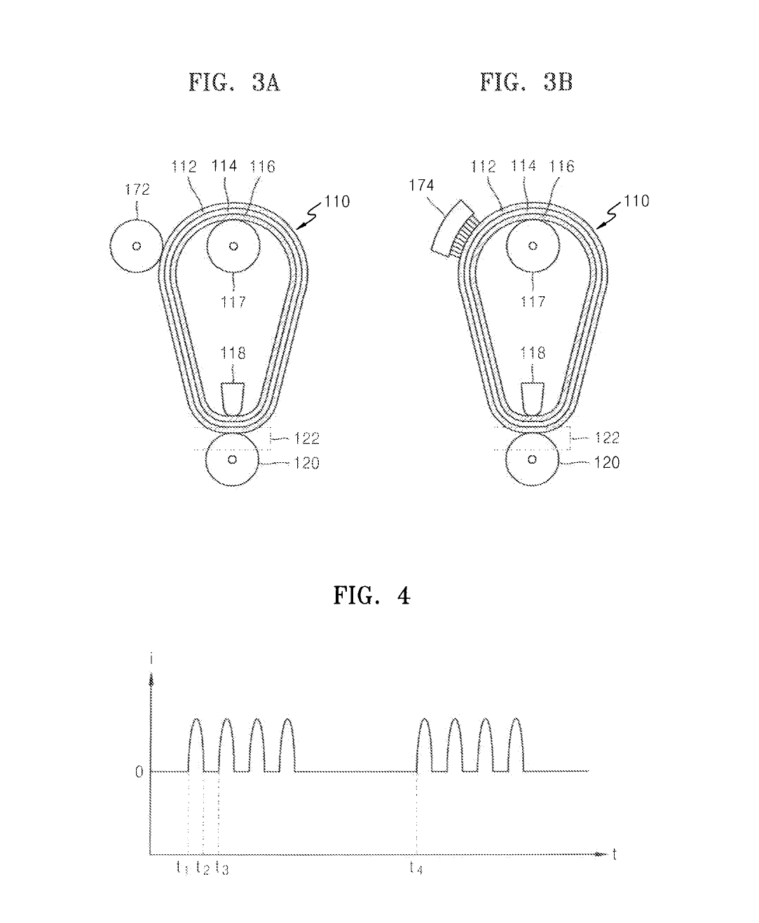

FIGS. 3A and 3B are diagrams illustrating configurations of fusing devices according to other embodiments of the present inventive concept. Although not illustrated in FIGS. 3A and 3B, each of the fusing devices of FIGS. 3A and 3B includes the current signal detector 130, the determination unit 140, the power breaker 150, and the power supplier 160 illustrated in FIG. 1. In the embodiments of FIGS. 3A and 3B, a path through which leakage current, which leaks out of the heat generation layer 114, flows to the ground does not include the pressurization roller 120 illustrated in FIG. 1 but includes a conductive roller 172 or a conductive brush 174. In this case, it is not necessary to form the pressurization roller 120 with a conductive material. If damage is generated in an insulation layer 112 of the fusing belt 110, a current flowing through the heat generation layer 114 flows to the ground through the conductive roller 172 or the conductive brush 174. The conductive roller 172 or the conductive brush 174 is connected to the ground to provide a path through which leakage current flows from the heat generation layer to the ground. Similar to FIGS. 2A and 2B, the conductive roller 172 or the conductive brush 174 may be connected to a frame ground, or may be connected to a power supply line in a Y-connection form.

FIG. 4 is a diagram illustrating a waveform of a current signal detected in the current signal detector 130. Below, it is explained in detail how the determination unit 140 analyzes the current signal and then determines whether there is leakage current, with reference to FIGS. 1 and 4. The current signal having the waveform illustrated in FIG. 4, as stated above, is a current signal corresponding to a difference between an input current, input to the heat generation layer 114 of the fusing belt 110, and an output current output from the heat generation layer 114. That is, the current signal detected in the current signal detector 130 has logic “0” when the input current and the output current are equal, whereas the current signal has a value other than logic “0” when the input current and the output current are different. Pulses generated at times t1, t3, and t4 of FIG. 4 represent moments at which the input current and the output current are not equal. Since a difference is generated between the input current and the output current when current leaks out of the heat generation layer 114, the current signal may become a pulse signal. However, even if the current signal is a pulse signal, it may not be determined for certain that current leaks out of the heat generation layer 114. This is because a pulse signal may be generated due to causes other than current leakage, such as static electricity and the like. A detailed method of clearly distinguishing a pulse signal generated due to current leakage from noise generated due to causes other than current leakage is as follows.

A first method is a method in which a frequency of the current signal is measured and then compared with a frequency of a power supply voltage that is supplied to the heat generation layer 114. If current leaks out of the heat generation layer 114, and then a pulse signal is generated due to the leakage current, a frequency of the pulse signal will be the same as that of the current flowing through the heat generation layer 114, namely, that of the power supply voltage supplied to the heat generation layer 114. Thus, it may be determined that current leaks out of the heat generation layer 114 if the frequency of the detected current signal is the same as that of the power supply voltage supplied from the power supplier 160, and it may be determined that a pulse signal is generated due to noise if the frequency of the detected current signal is not the same as that of the power supply voltage. For example, if it is assumed that the frequency of the power supply voltage, which is supplied from the power supplier 160, is 60 Hz, a period of the power supply voltage is 16.66ms. Since a pulse width of a pulse signal corresponds to half of a period of the pulse signal, a frequency of the pulse signal and the frequency of the power supply voltage are the same as each other if a time interval between t2 and t1 is 8.33 ms, which is half of 16.66 ms.

A second method is a method in which the number of pulses of the current signal is measured. It is widely expected that a current signal, i.e., a pulse signal, generated due to noise has only one or two pulses during a relatively short time. On the other hand, when current leaks out of the heat generation layer 114 due to damage of the insulation layer 112, it is widely expected that a current signal generated due to the damage of the insulation layer 112 will have a greater number of pulses compared to a current signal generated due to noise, since pulses will be continuously generated while the exposed heat generation layer 114 contacts the pressurization roller 120. Thus, only if the number of generated pulses is equal to or more than a predetermined value may it be determined that current leaks out of the heat generation layer 114. In addition, if the number of generated pulses is less than the predetermined value, it may be determined that noise is generated. The predetermined value is a value that a user may arbitrarily set according to a situation, and, for example, 3 or 4 may be the predetermined value.

A third method is a method in which a period, in which a pulse group including a plurality of pulses is generated, is compared with a rotation period of the fusing belt 110. Referring to FIG. 4, the current signal includes a pulse group including four pulses that are sequentially generated from time t1 and a pulse group including four pulses that are sequentially generated from time t4. If the insulation layer 112 is damaged at a point on the surface of the fusing belt 110, the damaged portion periodically contacts the pressurization roller 120 since the fusing belt 110 periodically rotates. Thus, a pulse group of the current signal is periodically generated whenever the damaged portion contacts the pressurization roller 120. In FIG. 4, a period in which a pulse group including four pulses is generated is t4-t1, and when the period coincides with the rotation period of the fusing belt 110, it may be determined that current leaks out of the heat generation layer 114.

The above three methods may be used independently or in combination with each other. A user may freely select whether the above three methods are used independently or in combination with each other, depending on the extent of required accuracy.

FIGS. 5 through 9 are flowcharts explaining a method of sensing leakage current of a fusing device of an image forming apparatus, according to an embodiment of the present invention. Referring to FIG. 5, in operation S501, a current signal, corresponding to a difference between an input current, that is input to a heat generation layer of a fusing belt, and an output current that is output from the heat generation layer, is detected. In operation S503, it is determined whether current leaks out of the heat generation layer by analyzing the detected current signal. If it is determined that current leaks out of the heat generation layer, a power supply to the heat generation layer is cut (operation S505). If it is determined that current does not leak out of the heat generation layer, operation S501 is performed again. In the present embodiment, it is possible to accurately sense current leakage by detecting a current signal corresponding to a difference between an input current of the heat generation layer and an output current of the heat generation layer and determining whether there is leakage current by analyzing the detected current signal. Thus, it is possible to prevent accidents such as an electric shock and a fire by cutting the power supply based on the determined result.

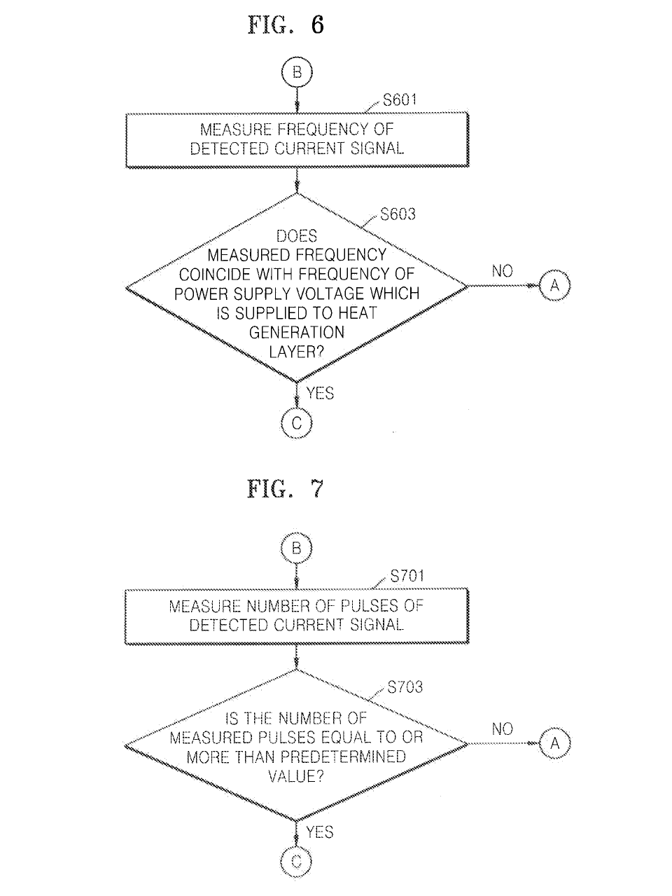

The operation S503, in which it is determined whether current leaks out of the heat generation layer by analyzing the detected current signal, will be explained in detail with reference to FIGS. 6 through 8. Referring to FIG. 6, in operation S601, a frequency of the detected current signal is measured. In operation S603, it is determined whether the measured frequency of the detected current signal coincides with a frequency of a power supply voltage supplied to the heat generation layer. If it is determined that the measured frequency of the detected current signal coincides with the frequency of the power supply voltage, operation S505 of FIG. 5 is performed. That is, in operation S505, the power supply to the heat generation layer is cut. If it is determined that the measured frequency of the detected current signal does not coincide with the frequency of the power supply voltage, operation S501 of FIG. 5 is performed. If leakage current leaks out of the heat generation layer, and a pulse signal is generated due to the current leakage, a frequency of the pulse signal will be the same as that of a current flowing through the heat generation layer, that is, that of the power supply voltage supplied to the heat generation layer. Thus, it may be determined that leakage current leaks out of the heat generation layer if the frequency of the detected current signal coincides with the frequency of the power supply voltage supplied from a power supplier to the heat generation layer, and it may be determined that a pulse signal is generated due to noise if the frequency of the detected current signal does not coincide with the frequency of the power supply voltage. A detailed method of determining whether the frequency of the detected current signal coincides with the frequency of the power supply voltage has already been described with reference to FIG. 4.

Referring to FIG. 7, in operation S701, the number of pulses of the detected current signal is measured. In operation S703, it is determined whether the number of measured pulses is equal to or more than a predetermined value. If it is determined that the number of measured pulses is equal to or more than the predetermined value, operation S505 of FIG. 5 is performed. That is, in operation S505, the power supply to the heat generation layer is cut. If it is determined that the number of measured pulses is less than the predetermined value, operation S501 is performed. Thus, only if the number of generated pulses is equal to or more than a predetermined value, may it be determined that current leaks out of the heat generation layer. However, if the number of generated pulses is less than the predetermined value, it may be determined that noise is generated.

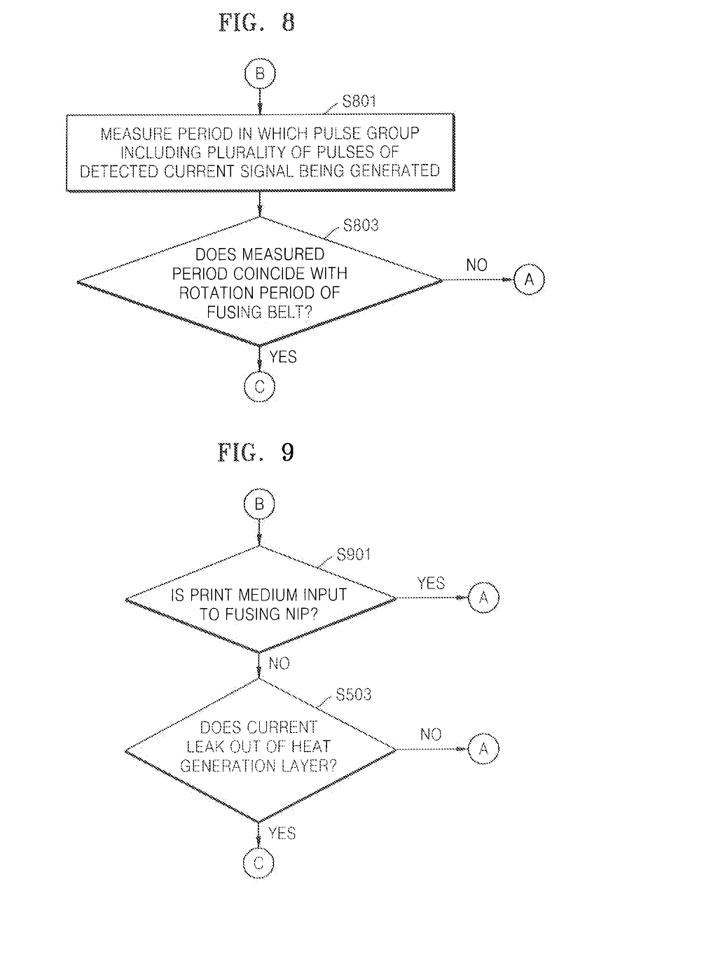

Referring to FIG. 8, in operation S801, a period in which a pulse group, including a plurality of pulses of the detected current signal being generated, is measured. In operation S803, it is determined whether the measured period coincides with a rotation period of the fusing belt. If it is determined that the measured period coincides with the rotation period of the fusing belt, operation S505 of FIG. 5 is performed. That is, in operation S505, the power supply to the heat generation layer is cut. If it is determined that the measured period does not coincide with the rotation period of the fusing belt, operation S501 of FIG. 5 is performed.

The determination methods explained with reference to FIGS. 6 through 8 may be used independently or in combination with each other. A user may freely select whether the determination methods are used independently or in combination with each other, depending on the extent of required accuracy.

FIG. 9 is a flowchart explaining a method of sensing leakage current of a fusing device of an image forming apparatus, according to another embodiment of the present invention. Referring to FIG. 9, in operation S901, it determined whether a print medium is input to a fusing nip. In a state in which the print medium is input to the fusing nip, even if a heat generation layer is exposed due to damage of an insulation layer of a fusing belt, the exposed heat generation layer does not contact a pressurization roller. In this case, since the print medium is between the exposed heat generation layer and the pressurization roller, the print medium functions as an insulation layer, and thus current does not leak out. Thus, in a state in which the print medium is input to the fusing nip, operation S501 of FIG. 5 is performed since it is difficult to accurately determine whether current leaks out. If it is confirmed that the print medium is not input to the fusing nip, operation S503 is performed. That is, it is determined whether current leaks out of the heat generation layer, based on an analysis result of the detected current signal.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims. Accordingly, the disclosed embodiments should be considered in an illustrative sense and not in a limiting sense. The scope of the present invention is defined not by the detailed description of the present invention but by the appended claims, and all differences within the scope will be construed as being included in the present invention.

What is claimed is:

1. A fusing device of an image forming apparatus comprising a fusing element in which a heat generation layer is formed and a pressurization element that forms a fusing nip by pressurizing and contacting the fusing element, the fusing device comprising:
a power supplier to supply a power supply voltage to the heat generation layer to heat the heat generation layer;
a current signal detector to detect a current signal corresponding to a difference between an input current of the heat generation layer and an output current of the heat generation layer;
a determination unit to determine whether a current leaks out of the heat generation layer by analyzing the current signal detected by the current signal detector; and
a power breaker to prevent the power supply voltage supplied from the power supplier from being supplied to the heat generation layer, if the determination unit determines that a current leaks out of the heat generation layer.

2. The fusing device of claim 1, wherein the determination unit determines that a current leaks out of the heat generation layer if a frequency of the current signal detected in the current signal detector coincides with a frequency of the power supply voltage supplied to the heat generation layer.

3. The fusing device of claim 1, wherein the determination unit determines that a current leaks out of the heat generation layer if the number of pulses of the current signal detected in the current signal detector is equal to or more than a predetermined value.

4. The fusing device of claim 1, wherein the fusing element comprises a roller or belt that rotates at a predetermined period, and the determination unit determines that a current leaks out of the heat generation layer if a period in which a pulse group comprising a plurality of pulses of the current signal being generated coincides with the rotation period of the fusing element.

5. The fusing device of claim 1, wherein the pressurization element comprises a conductive material and allows a current leaked out of the heat generation layer of the fusing element to flow to the ground.

6. The fusing device of claim 5, wherein, only if the print medium is not input to the fusing nip, the determination unit determines whether a current leaks out of the heat generation layer.

7. The fusing device of claim 5, wherein the pressurization element is connected to an input-output power supply line of the heat generation layer in a Y-connection form.

8. The fusing device of claim 1, further comprising a conductive element allowing a current leaked out of the fusing element to flow to the ground by contacting the fusing element at one or more points of the fusing element.

9. The fusing device of claim 8, wherein the conductive element comprises a roller form that contacts the fusing element and rotates as the fusing element rotates or a brush form that contacts the fusing element at a fixed position.

10. The fusing device of claim 8, wherein the conductive element is connected to an input-output power supply line of the heat generation layer in a Y-connection form.

11. A method of sensing a leakage current of a fusing device of an image forming apparatus comprising a fusing element in which a heat generation layer is formed and a pressurization element that forms a fusing nip by pressurizing and contacting the fusing element, the method comprising:
supplying a power supply voltage to the heat generation layer to heat the heat generation layer;
detecting a current signal corresponding to a difference between an input current of the heat generation layer and an output current of the heat generation layer;
determining whether a current leaks out of the heat generation layer by analyzing the detected current signal; and
preventing the power supply voltage from being supplied to the heat generation layer, if it is determined that a current leaks out of the heat generation layer.

12. The method of claim 11, wherein the determining comprises determining that a current leaks out of the heat generation layer if a frequency of the detected current signal coincides with a frequency of the power supply voltage supplied to the heat generation layer.

13. The method of claim 11, wherein the determining comprises determining that a current leaks out of the heat generation layer if the number of pulses of the detected current signal is equal to or more than a predetermined value.

14. The method of claim 11, wherein the fusing element comprises a roller or belt that rotates at a predetermined period, and the determining comprises determining that a current leaks out of the heat generation layer if a period in which a pulse group comprising a plurality of pulses of the detected current signal being generated coincides with the rotation period of the fusing element.

15. The method of claim 11, wherein the pressurization element comprises a conductive material and allows a current leaked out of the heat generation layer of the fusing element to flow to the ground, and, in this case, the determining is performed only if the print medium is not input to the fusing nip.

16. A computer-readable recording medium having recorded thereon a program for executing a method of sensing a leakage current of a fusing device of an image forming apparatus comprising a fusing element in which a heat generation layer is formed and a pressurization element that forms a fusing nip by pressurizing and contacting the fusing element, the method comprising:
supplying a power supply voltage to the heat generation layer to heat the heat generation layer;
detecting a current signal corresponding to a difference between an input current of the heat generation layer and an output current of the heat generation layer;
determining whether a current leaks out of the heat generation layer by analyzing the detected current signal; and
preventing the power supply voltage from being supplied to the heat generation layer, if it is determined that a current leaks out of the heat generation layer.

17. A fusing device of an image forming apparatus comprising:
a fusing belt including a heat generation layer configured to receive a power supply voltage in order to heat the generation layer;
a pressurization element which forms a fusing nip by pressurization contact between the fusing belt and the pressurization element;
a current signal detector to detect a change in a current signal of current that flows into the heat generation layer and current that flows out of the heat generation layer; and
a determination unit to determine whether a current leaks out of the heat generation layer by analyzing the current signal.

18. The fusing device according to claim 17, further comprising:
a power breaker to prevent the heat generation layer from receiving the power supply voltage when the determination unit determines that there is a current leakage.

19. The fusing device according to claim 17, wherein the current signal detector includes an amplifier, and wherein the current signal detector amplifies the detected current signal and transmits the amplified current signal to the determination unit.

20. The fusing device according to claim 17, wherein the current signal detector includes a zero current transformer to detect a current signal corresponding to a difference between a first current, which flows through an input power supply line into the heat generation layer, and a second current which flows through an output power supply line from the heat generation layer.
